(19) United States
(12) Patent Application Publication
(10) Pub. No.: US 2014/0195032 A1
(43) Pub. Date: Jul. 10, 2014

(54) METHOD FOR THE DEMAND-CONTROLLED SUPPLY TO AND DISPOSAL AWAY FROM AT LEAST TWO PRODUCTION STATIONS OF THE TOBACCO PROCESSING INDUSTRY WITH FULL AND/OR EMPTY TRANSPORT UNITS

(71) Applicant: Hauni Maschinenbau AG, Hamburg (DE)

(72) Inventors: Matthias Horn, Ahrensburg (DE); Rüdiger Ulrich, Hamburg (DE); Thomas Flügge, Geesthacht (DE); Dagmar Dittmar, Hamburg (DE); Jan Kreysern, Bovenden (DE); Walter Kitzing, Pinneberg (DE); Carsten Becker, Wentorf (DE); Uwe Busse-Riepshoff, Buchholz (DE)

(73) Assignee: HAUNI MASCHINENBAU AG, Hamburg (DE)

(21) Appl. No.: 14/151,578

(22) Filed: Jan. 9, 2014

(30) Foreign Application Priority Data
Jan. 9, 2013 (EP) 13150669.3

(51) Int. Cl. G06Q 10/06

(52) U.S. Cl. CPC G06Q 10/06
USPC 700/115

(57) ABSTRACT

A method for demand-controlled supply to and disposal away from production stations. Self-propelled transport vehicles are moved on a rail within an overhead storage and transport system. A transport unit is requested by a transfer unit which forms a linking member between the storage and transport system and an associated production station. A transport task is assigned by a material flow control to a transport vehicle. The transport vehicle is moved in the transport plane on the rail from a start position to the transfer unit of a production station initiating the transport task. The transport unit is transferred to the transfer unit. The full or empty transport unit is lowered by a lift into a transfer plane located below a transport plane. The transport vehicle is released for the next transport task after the transfer of the full or empty transport unit to the transfer unit.

### CROSS-REFERENCE TO RELATED APPLICATIONS

Priority is claim with respect to European Application No. 13 15 0669.3 filed in the European Patent Office on Jan. 9, 2013, the contents of which is incorporated herein by reference in its entirety.

### BACKGROUND OF THE INVENTION

The invention relates to a method for the demand-controlled supply to and disposal away from at least two production stations of the tobacco processing industry with full and/or empty transport units, said transport units being moved by rail, by means of self-propelled conveying vehicles within a storage and transport system which is designed as an overhead system with a central store as a storage system comprising at least one storage shelf and a rail network forming part of the transport system, to which each production station is associated for the supply of each production station and for the disposal away from each production station.

Such methods are used in the tobacco processing industry in order to supply the production stations with the articles required for production or, respectively, to retrieve the respectively produced articles from the respective production station. A coupling of production stations is assisted by the aforementioned method, said production stations, for example, having different production speeds or, respectively, production capacities or, respectively, on which different brands are produced. In other words, an independent production of the individual production stations is desired. The tobacco processing industry relates not only to the manufacture of intermediate products containing tobacco and finished products but also specifically the manufacture of (intermediate) products which do not have to contain any tobacco, such as, for example, the filters and the packaging of such articles. In other words, such methods are used in order to control the material flow, in particular within a filter and cigarette production process i.e. to coordinate the transport and storage of filter rods and cigarettes for cigarette manufacture and packaging.

In addition to methods, for example, for manufacturing cigarettes or filter cigarettes, therefore, the generic method also encompasses, for example, such methods which are exclusively oriented to the manufacture of filters or multi-segment filters as well as the packaging of the aforementioned articles. The aforementioned articles are manufactured by means of production stations, wherein production stations are able to be both the so-called makers, i.e. manufacturing machines, for example of the KDF, PROTOS type manufactured by the applicant, or machines for further processing, for example a filter assembly machine of the MAX type or a multi-segment filter manufacturing machine of the MERLIN type manufactured by the applicant, and also filter feed stations manufactured by the applicant, for example known as the FILTROMAT type, or so-called packers for packaging the manufactured articles. The machines for further processing, however, may also be manufacturing machines. The phrase “manufacture of products of the tobacco processing industry” is understood as the manufacture or, respectively, production both of all intermediate products and all finished products. Purely by way of example, as intermediate products, which are also called semi-finished products, e.g., filters, filter segments, milliners, tobacco rods, or the like may be cited. The finished products may, for example, be cigarettes, filter cigarettes, cigarette packaging, cigarette blocks formed from a plurality of cigarette packages and further finished products or end products common in the tobacco processing industry. However, the intermediate products cited above may also be finished products.

In principle, the storage or temporary storage of the intermediate products or finished products is expedient (for example for stored reserves) and/or necessary (for example for curing processes, etc). To this end, the intermediate products or finished products are filled into transport units at the respective production stations, supplied to a storage system by means of the transport system and stored there, transported again to a production station for further processing and emptied there, which is why stations corresponding to the production stations are provided for altering the filling level of the transport units, i.e. apparatuses for filling and/or emptying the transport units.

In order to supply all of said articles of the tobacco processing industry, i.e. the intermediate products, the finished products but also materials and additives used in the manufacture of said intermediate products and finished products, to a reservoir and/or to transport said products from the reservoir to the respective production stations, transport systems are known by means of which the products which are stored in or on a transport carrier, are transported from a production station to a storage area in the reservoir and from a storage area of the reservoir to a production station. The storage and transport system forms a type of linking member between the individual production stations. In other words, the storage and transport system connects together the production stations for manufacturing the intermediate products and the finished products and the stations for filling and/or emptying the transport units, so that a type of closed logistics system is formed with at least one inlet and at least one outlet.

For example, cabinet or shelf systems are known in the prior art as a storage and transport system, (as reservoirs with at least one storage area) with compartments for receiving individual transport units or transport units combined into groups, wherein the articles are conveyed directly or indirectly via the transport units by means of a handling or, respectively, transport system within the arrangement. From the prior art, for example, so-called ground conveyor systems are known as handling or, respectively, transport systems. In said systems, the transport vehicles are driven and moved on the ground along guides or, respectively, loop guides, arranged in the ground. Such systems, however, in addition to a very high space requirement on the ground, have the further drawback that the driverless transport vehicles constitute a risk for personnel located in the region of the arrangement. Moreover, such a transport system is only able to be used actively in one plane (on the ground) which limits the options for use. A corresponding ground conveyor system is disclosed, for example, in the German published patent application DE 25 38 567.

It is also known from the prior art to use suspended conveyor systems as transport systems. The German published patent application DE 2 107 825 discloses a gondola system in which the transport units are transported by being suspended. This has the drawback, however, that the articles or, respectively, materials located in or on the transport units tend to swing or rock with the gondolas, which in particular with rod-shaped articles, i.e. articles with a round, or substantially round, cross section, such as for example filters, filter segments, tobacco rods and the like, has the result that said articles are displaced within the transport unit and are misaligned. In this context, said articles are also referred to as so-called non-aligned filter rods.

The known systems and methods, however, in addition to the aforementioned drawbacks of the conveying system have the problem that they are very static i.e. not very flexible relative to production planning and, moreover, have long conveying sections and conveying times when feeding the individual production stations, whereby the material flow within the system is limited. A further drawback is that the known methods are limited to the supply and disposal of rod-shaped articles, whereby the flexibility of such methods and systems is also limited. In other words, various operating or, respectively, method steps have to be carried out manually, whereby the stress on the operating personnel is high and the risk of errors exists.

### SUMMARY OF THE INVENTION

Accordingly, an object of the invention is to propose a method which increases the options for production planning and optimises the material flow between the production stations.

This object is achieved by a method cited hereinbefore which is characterised by the following steps: a) requesting a full or empty transport unit which is available within the storage and transport system, by a transfer unit, which forms a linking member between the storage and transport system and the associated production station, with a material flow control, b) assigning a transport task by the material flow control to a transport vehicle with the requested full or empty transport unit, c) moving the transport vehicle with the full or empty transport unit in the transport plane on the rail network from the start position of the transport vehicle as far as the transfer unit of a production station initiating the transport task, said production station being located in a production plane below the transport plane, d) transferring the full or empty transport unit from the transport vehicle to the transfer unit in a transfer position, e) lowering the full or empty transport unit by means of a lift arrangement from the transport plane into a transfer plane located below the transport plane, wherein the steps d) and e) are also able to be carried out in reverse sequence and the transport vehicle is released for the next transport task after the transfer of the full or empty transport unit to the transfer unit. The solution according to the invention to transport the transport vehicles with the full and/or empty transport units separately from the ground, i.e. above the ground plane (“overhead”), is clearly more space-saving relative to the conventional methods and offers the possibility of transporting the transport units on the shortest paths, i.e. optimised in terms of material flow to the respective target locations. Moreover, the method simplifies the simple and stepwise incorporation/implementation in existing production systems. The method according to the invention, in addition to the elimination of manual activity during the supply and disposal of full and/or empty transport units to the production stations, ensures several further advantages which are listed hereinafter. The manufacturing machines for the rod-shaped articles, for example, are decoupled from a packaging machine so that the individual production machines may carry out production processes independently of one another. In particular, the production planning is enhanced by the optimised material flow as, by decoupling the makers from the packers, different times may be selected for changing brand on the makers, on the one hand, and the packers, on the other hand. The material flow control as a control unit with hardware and software components may also be denoted as a traffic computer and comprises a network between the individual production stations as well as the storage and transport system with the transport vehicles, in order to ensure a demand-controlled supply of material to the production stations. The request for the transport unit is carried out in principle by the respective transfer device. However, this message may also be emitted from production stations via the transfer unit.

Advantageously, in addition to the transfer units, buffer stores also configured in the region of the rail network and/or intermediate stores assigned to the transport system which, as a decentralised store comprising at least one storage shelf, in addition to the central store, form part of the storage system, request full or empty transport units with the material flow control and transport vehicles are delivered thereto. As a result, a shortening of the conveying section or, respectively, a compensation of the conveying time may be achieved as requested transport units are available at different positions within the storage and transport system. A further advantage of decentralised stores is that the individual storage areas may be separated from one another more easily. Moreover, local reservoirs may be minimised, for example in the region of the transfer units. The capacity of the buffer stores and the intermediate stores may be variable and depends, for example, on the length of the respective conveying section (conveying time) and the capacity of the associated production station.

In an expedient development of the method, the transport tasks are assigned priorities in sequence, the priority optionally being determined from the urgency and/or the precedence of a material and/or the precedence of a transfer unit or, respectively, production station and/or the precedence of a buffer store or an intermediate store and/or the precedence of production tasks by the material flow control. The individual criteria in turn may be prioritised or, respectively, weighted. Thus the supply/disposal may be adapted flexibly and individually to the respective (customer) requirements. In particular, the supply of production stations with full transport units may take place according to the FIFO principle, in order to avoid overageing of the articles located in the storage and transport system.

Expediently, the transport tasks are assigned by the material flow control to those transport vehicles which require the shortest overall time for carrying out the transport task, considering the start-up time and the conveying time. The selected or, respectively, required transport vehicles may, therefore, optionally start from a storage shelf of the storage system (for example central store, decentralised store) or from any position of the rail network. In particular, the time which the transport vehicle requires in order to retrieve the requested transport unit from the central store or the decentralised store or, respectively, from a reservoir optionally assigned to the transfer unit is denoted as the start-up time. In the buffer store or at any other position on the rail system, the transport units are already arranged on the transport vehicle, which is why the start-up time is zero. Only a conveying time has to be taken into consideration. This embodiment of the method optimises the material flow within the storage and transport system.

The method according to the invention is optionally developed in that two sub-tasks are handled by a single conveying task, by a full transport unit being transferred from the transport vehicle to the transfer unit and subsequently an empty transport unit being transferred from the transfer unit to the same transport vehicle, or vice versa. Put simply, for example, travel times without articles/material, i.e. so-called empty journeys, may be minimised by combining transport tasks, whereby the conveying and/or waiting times may be further reduced.

An advantageous development is characterised in that the full or empty transport units, which in each case are formed from a load carrier and a loaded goods carrier, after transfer from the transport vehicle to the transfer unit are conveyed by the lift arrangement vertically downwards into a first transfer plane, the full or empty loaded goods carrier being removed from the load carrier in the lower transfer plane, transported to a station for altering the filling level of the loaded goods carrier and transferred thereto. The load carriers are passive aids for storing and transporting the loaded goods carriers. The loaded goods carriers in turn are the aids carrying the articles or the material. For example, trays, boxes, containers, pallets, support shafts for bobbins or tool carriers are loaded goods carriers. As the transport units are lowered onto the transfer unit only after transfer from the storage and transport system, the transport vehicle is free again in good time so that said transport vehicle is available for subsequent transport tasks. Moreover, the transport vehicles move outside the central store and/or the distributed stores exclusively in the transport plane, i.e. they do not leave the transport system, which firstly has the result that transferring the transport vehicles may be dispensed with and secondly it is ensured that the transport units to be transported are handled at low load within the transport system.

Preferably, after removing the loaded goods carrier, the load carrier is transported vertically downwards or upwards into a second transfer plane located below the transport plane, in order to receive a loaded goods carrier with an altered filling level, the loaded goods carrier with the altered filling level being transferred to the load carrier and the transport unit reset thereby then being transported vertically upwards into the transport plane in which the transport unit is transferred to a transport vehicle previously requested and provided by the material flow control. Thus the principle of “dual tasking” is assisted by the number of empty journeys being reduced. The load carrier which has become free by removing the loaded goods carrier may be reloaded immediately with a transport unit, namely on the same transfer unit and moved to the transport vehicle which may be implemented by a conveying section which is reduced to a maximum extent in order to optimise the material flow.

An expedient development is characterised in that the central store and/or each decentralised store and/or each buffer store is controlled or, respectively, managed by a storage management system. In other words, the storage management system controls the production stations and the warehouse stock based on the planning data of a superordinate production planning system (PPS in short) via a network which connects the production planning system to the storage management system and to the production stations. To this end, the storage management system is optionally connected to the material flow control. By such a method sequence, an optimal implementation of the transport tasks initiated by the material request in step a) is achieved.

Advantageously, free transport vehicles and transport vehicles provided with full or empty transport units move within the storage and transport system in order to deliver, on the one hand, full or empty transport units to a transfer unit and, on the other hand, to retrieve transport units altered in the filling level from a transfer unit. By the permanent provision of both free and loaded transport vehicles within the storage and transport system, the conveying sections or, respectively, conveying times may be optimised.

The method is particularly well suited to handling trays as loaded goods carriers. The method is thus optionally developed in that at least one transfer unit which is assigned to a tray filler, which in turn is assigned to a maker, namely a filter manufacturing machine or a cigarette manufacturing machine, requests empty trays as loaded goods carriers to receive rod-shaped articles, the empty trays together with the load carrier being transported into the lower transfer plane, removed there from the load carrier and transported to the tray filler and transferred thereto.

Advantageously, the trays filled by the tray filler are transferred back to the transfer unit and transferred therefrom to a requested load carrier which is optionally already available on the transfer unit or delivered by a transport vehicle, the full transport units formed from the load carrier and trays being transported from the transfer plane upwards into the transport plane and transferred there to the requested transport vehicle so that the full transport unit is introduced into the storage and transport system for further use. The storage of full trays is significant in the example of filters, in order that the filters are able to cure during the storage time.

The method is optionally also developed in that at least one transfer unit which is assigned to a tray discharger which in turn is assigned to a maker, namely a filter assembly machine or a packaging machine or a multi-segment filter manufacturing machine, requests full trays as loaded goods carriers with rod-shaped articles, the full trays together with the load carrier being transported into the lower transfer plane, removed there from the load carrier and transported to the tray discharger and transferred thereto.

Advantageously, the trays emptied by the tray discharger are transferred back to the transfer unit and transferred therefrom to a requested load carrier which optionally is already available at the transfer unit or delivered from a transport vehicle, the empty transport units formed from the load carriers and trays being transported from the transfer plane upwards into the transport plane and transferred there to the requested transport vehicle so that the empty transport unit is introduced into the storage and transport system for further use.

Preferably, a guard hood assigned to the load carrier is removed from the load carrier before being transported into the transfer plane and after being transported back into the transport plane is placed onto the load carrier. The guard hood protects, the articles to be transported. The removal of the guard hood permits the emptying or, respectively, filling of the trays. The positioning ensures that the articles located in the trays are protected.

By the method steps cited in combination with the handling of trays, the decoupling of the individual production stations from one another is achieved, i.e. in particular the separation of makers and packers, and permits a demand-based and flexible material flow between the production stations which is also able to be altered in terms of location and chronology. In other words, each production station is initially able to produce and supply to the storage and transport system independently from the other production stations, whilst other production stations may be supplied with the required material from the storage and transport system independently from the other production stations. By the optimised material flow, improved production capacities of the individual production stations may be achieved at different production speeds. The degree of utilisation of the production stations is increased by the permanent and uninterrupted operation. It is even possible to compensate for the malfunction of individual production stations. By means of the method according to the invention, articles, for example cigarettes, may also be produced “in storage” so that the number of brand changes and the waiting times resulting from the brand changes may be reduced.

It is particularly advantageous if at least one transfer unit which is assigned to a bobbin loader which in turn is assigned to a maker, namely a filter manufacturing machine or a cigarette manufacturing machine or a packaging machine or a film wrapper, requests a load carrier with a loaded goods carrier carrying at least one bobbin, the at least one loaded goods carrier carrying at least one bobbin together with the load carrier being transported into the lower transfer plane, removed from the loaded goods carrier and transported to the maker and transferred thereto, the load carrier which is without a loaded goods carrier being subsequently transported from the transfer plane upwardly into the conveying plane and transferred there to the requested conveying vehicle, so that the empty load carrier is introduced into the storage and transport system for further use. By means of this optional method step, in addition to the rod-shaped articles, i.e. for example the filters or cigarettes, also the material required for manufacturing the aforementioned articles, such as for example plug wrappers for the filter manufacture, cigarette paper and/or tipping paper for the cigarette manufacture as well as packaging material for the packaging, is transported from the storage and transport system to transfer units without the intervention of an operator. In other words, the supply/disposal is fully autonomous and the material flow thus optimised.

Optionally at least one transfer unit may request a load carrier with a loaded goods carrier receiving spare parts and/or wearing parts, the loaded goods carrier carrying the spare parts and/or wearing parts, together with the load carrier, being transported into the lower transfer plane and removed there from the load carrier, the load carrier being subsequently transported with an empty loaded goods carrier or without a loaded goods carrier from the transfer plane upwards into the transport plane and transferred there to the requested transport vehicle, so that the free load carrier or, respectively, the empty loaded goods carrier is introduced for further use into the storage and transport system. The spare parts and/or wearing parts are also denoted as production aids, in addition to such materials which contribute to the manufacture of rod-shaped articles and the packaging thereof, i.e. in particular consumable materials, such as for example glue. For example suction belts or blades are cited as wearing and/or spare parts of the production stations, as well as further packaging materials not wound onto bobbins, such as for example blanks for cigarette packaging, coupons, stamps and cardboard boxes. Thus the method is even more independent of the intervention of operators as the material flow is controlled completely and automatically which also reduces the risk of error. The method step according to the invention moreover aids a “tidy” environment at the individual production stations by the storage in the central store, in the decentralised store, in the buffer store or in the transport system as the supply of requested materials only takes place in case of need. Moreover, only the required quantity of material is transported to the transfer unit which reduces the quantity of returns, for example when changing brand. By this method according to the invention, all transfer units, even those which are assigned manual working spaces or distribution centres, are handled in a common storage and transport system with all production aids required for manufacturing and packaging and for maintaining the production operation, which optimises the entire material flow in terms of time and distance.

Advantageously, the supply of the transfer unit with the spare parts and/or wearing parts is initiated by an operator or a maintenance plan or requirement plan stored in the material flow control. In particular, by initiating the supply by the maintenance plan stored in the material flow control, a continuous production operation is maintained by the optimised material flow.

Preferably, a free load carrier is requested by a transfer unit in order to retrieve a loaded goods carrier provided with the tail strip. As the possibility is provided of the automatic return of the tail strip, for example when changing the brand or at the end of production, the materials are more efficiently consumed and, in particular, wastage reduced. In particular, bobbins which are not completely used up may, as a result, be fed back into the storage and transport system.

The method is advantageously developed in that the full or, respectively, loaded and empty loaded goods carriers are stored in the central store, decentralised store, buffer store, on the rail network or directly in the transfer unit with or without a load carrier and with or without a transport vehicle. As loaded goods carriers may be available virtually everywhere for completing a transport task, even on transport vehicles which are currently carrying out a different transport task, a maximum short conveying section or, respectively, conveying time may be achieved partially even without a start-up time, whereby the material flow is optimised. As a result, for all requests the loaded goods carrier which is most advantageously positioned may be optionally selected and activated in each case to the position initiating the transport task, preferably the transfer units and the buffer store, for delivering the requested loaded goods carrier in order to carry out the transport task.

Expediently, the transport vehicles and/or the load carriers and/or the loaded goods carriers and/or the material to be transported are localised and/or tracked by machine-readable and/or electronic identification carriers. This simplifies the product tracking system in the storage and transport system and in the transfer units and product stations associated therewith. Via the product tracking, the respective position of all transport vehicles and/or load carriers and/or loaded goods carriers and/or the material transported therein may be identified. Moreover, the movement history may be tracked so that, for example, materials unsuitable for further processing and faulty materials may be identified and ejected.

Advantageously, the localisation and/or tracking takes place via a satellite navigation system and at least one indoor transmitter. By the satellite navigation system and the so-called “indoor transmitter” an accurate and rapid product tracking system may be ensured.

The method is optionally developed in that empty trays are fully emptied and/or cleaned in the vicinity of the tray discharger and/or immediately before being supplied to the tray filler. This step may also be denoted as providing conformity to the empty trays. An empty tray is denoted as not having conformity if said empty tray is not completely empty before being supplied to a tray filler. Each tray is, therefore, emptied and/or cleaned before the supply in order to avoid undesired mixing of articles in the trays.

Preferably, the full trays after being filled in the tray filler are checked in the region between the tray filler and the transfer unit for conformity and such full trays which are identified as not having conformity are prevented from being introduced into the storage and transport system. This method step, also denoted as providing conformity to the full trays, comprises, for example, the monitoring of the filling level and the filling image, the monitoring of so-called non-aligned filter rods and protruding articles as well as grade purity, the degree of soiling and damage to the articles as well as the trays themselves. This checking of the conformity which may be carried out manually or automatically results in the case of an identified non-conformity in preventing the supply of the tray into the storage and transport system.

A preferred development is characterised in that, when transferred by means of a transfer unit from the storage system to the transport system, the bobbins are checked for their conformity and such bobbins which are identified as not having conformity are prevented from being introduced into the transport system. A bobbin is denoted as having non-conformity if, for example, the state of the bobbin wrapper tab is critical or the bobbin has been telescoped.

Preferably, the loaded goods carrier and, in particular, the full trays filled with rod-shaped articles are weighed before storing in the storage system and after removing from the storage system. As a result, the degree of dryness may be identified in the example of cigarettes in the full trays. The cigarettes lose moisture during storage. If the cigarettes are stored for a lengthy period of time, for example more than 24 hours in a reservoir, the moisture is so low, associated with a significant loss of weight, that further processing is prevented.

To this end, a weight difference is expediently detected which, when exceeding an upper limit value and when falling below a lower limit value, initiates the ejection of loaded goods carriers from the storage and transport system via a transfer unit.

An advantageous development of the method is characterised in that full loaded goods carriers, i.e. provided with material, are transferred according to predetermined criteria and/or randomly directly from the storage and transport system into a quality securing station. The direct coupling of a quality securing station to the storage and transport system or via a transfer unit permits monitoring during the production operation. Via the assignment and product tracking system and the movement history thereof, conclusions may be drawn about the production station so that from the results of the quality securing, the corresponding measures may be taken rapidly, for example resetting the machine parameters of the production station or even the shutdown of the production station.

### BRIEF DESCRIPTION OF THE DRAWINGS

Further expedient and/or advantageous features and developments are revealed from the sub-claims and the description. The method principle according to the invention is described in more detail with reference to the accompanying drawings, in which:

FIG. 1 shows a schematic overview of an intralogistics system which is used in the tobacco processing industry,

FIG. 2 shows a schematic flow diagram of a transport task,

FIG. 3 shows a schematic flow diagram of a transfer unit,

FIG. 4 shows a schematic view of the network connection within the system.

FIG. 5 a) to e) show schematic views of transport units,

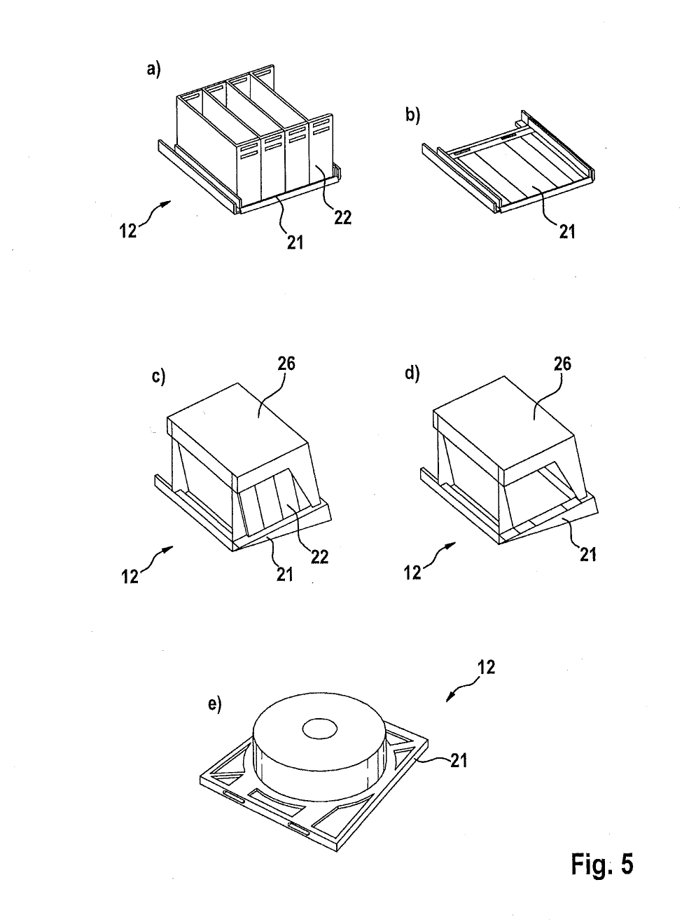

FIG. 6 shows a schematic view of a transport vehicle, and

FIG. 7 shows a schematic view of the region of a transfer unit.

### DETAILED DESCRIPTION

In the drawings, the method according to the invention is described by way of example with reference to an intralogistics system of the tobacco processing industry. The invention, however, also relates expressly to the methods of other fields, in which a plurality of production stations, i.e. for example manufacturing machines, packaging machines, etc. communicate with a storage and transport system in the form of an exchange of material with one another. Moreover, only exemplary sequences, for example for handling trays within the cigarette industry, are described in the drawings. Further sequences, not shown, for example for handling bobbins or the like, however, are also encompassed by the invention.

The method according to the invention describes—preferably for an intralogistics system 10 in cigarette and/or filter rod production—the demand-controlled supply to and disposal away from at least two production stations 11 of the tobacco processing industry with full and/or empty transport units 12, said transport units being moved by rail, by means of self-propelled transport vehicles 30 within a storage and transport system which is configured as an overhead system with a central store 13 as a storage system 14 comprising at least one storage shelf and a rail network 16 forming part of the transport system 15, to which each production station 11 is associated for the supply of each production station 11 and for the disposal away from each production station 11.

This method is characterised by the following steps: a) requesting a full or empty transport unit 12 which is available within the storage and transport system 14, 15, by a transfer unit 17, which forms a linking member between the storage and transport system 14, 15 and the associated production station 11, with a material flow control 18, b) assigning a transport task by the material flow control 18 to a transport vehicle 30 with the requested full or empty transport unit 12, c) moving the transport vehicle 30 with the full or empty transport unit 12 in the transport plane on the rail network 16 from the start position of the transport vehicle 30 as far as the transfer unit 17 of a production station 11 initiating the transport task, said production station being located in a production plane below the transport plane, d) transferring the full or empty transport unit 12 from the transport vehicle 30 to the transfer unit 17 in a transfer position, e) lowering the full or empty transport unit 12 by means of a lift arrangement from the transport plane into a transfer plane located below the transport plane, wherein the steps d) and e) are also able to be carried out in reverse sequence and the transport vehicle 30 is released for the next transport task after the transfer of the full or empty transport unit 12 to the transfer unit 17.

The method according to the invention is accordingly characterised in that a plurality of production stations 11 are associated with a storage and transport system 14, 15, and each production station 11 is connected via a transfer unit 17 to the storage and transport system 14, 15 so that by eliminating manual activity/manual intervention, transport units 12 may be delivered and retrieved with and without material between the storage and transport system 14, 15 and the production stations 11 as well as between production stations 11 via the storage and transport system 14, 15. The associated production stations 11 may be manufacturing machines, packaging machines or even manual working areas or distribution areas. It is significant that the entire material flow, which in addition to the filter rods, cigarettes, other rod-shaped articles, etc. as well as other materials and products required for manufacturing the articles of the tobacco processing industry, also expressly includes components required for the transport of the above articles, materials and products, is controlled, coordinated and monitored via the material flow control.

The method steps and developments described hereinafter, considered per se or combination with one another, represent preferred embodiments of the invention. Reference is expressly made to the fact that the method steps which are combined in the claims and/or description of the figures may also develop the method described above in a functionally independent manner.

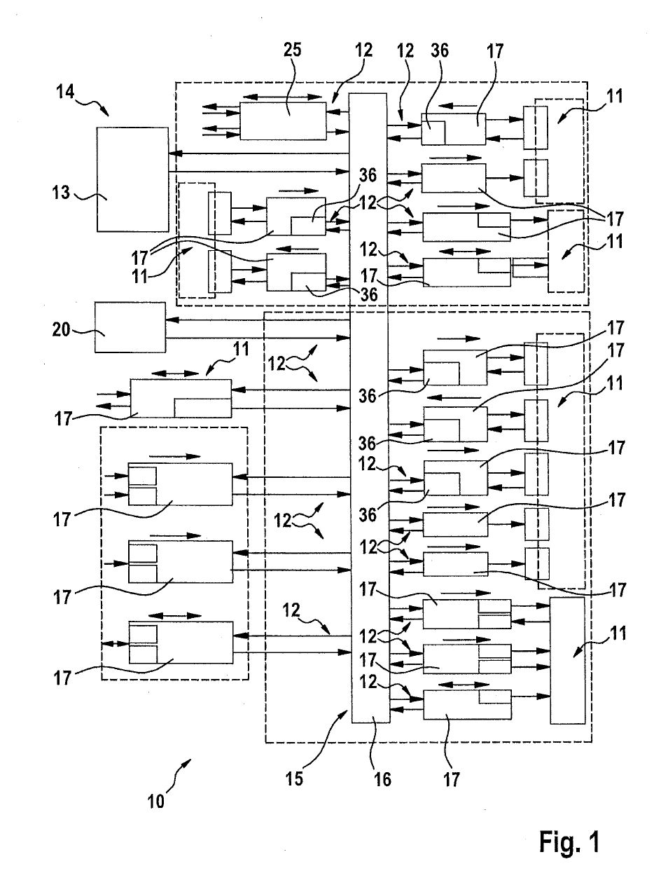

In FIG. 1 virtually all possible options are combined in one view. The method according to the invention, however, may also simply comprise parts of the system 10, for example when only makers or exclusively packaging machines are coupled to the storage and transport system 14, 15.

The storage and transport system 14, 15 is configured as an overhead system which means that the transport plane extends separately from the ground, above the ground plane in which or, respectively, on which the production stations 11 are arranged. The storage system 14 in turn comprises the central store 13 with at least one storage shelf, each storage shelf being provided with a scalable number of shelves, the storage surfaces thereof being arranged in horizontal shelf planes and vertical shelf rows. The individual shelves are positioned spaced apart from one another so that in the gaps between the shelves the storage and removal from storage of transport units 12 may take place by means of the transport vehicles 30. At the same time, a plurality of transport vehicles 30—also in different shelf planes—may be moved in each gap. The transport vehicles 30 move from the front faces into the gaps. On one side of each gap, or on both sides of each gap, is located a lift arrangement in order to permit the transport vehicles 30 to move to and fro between the shelf planes and in order to move the transport vehicles 30 ultimately into the transport plane.

The transport system 15 is located in the transport plane and comprises the rail network 16. The transport vehicles 30 are able to be moved independently on the rail network 16. The self-propelled transport vehicles 30 are in turn designed and adapted for receiving and dispensing the transport units 12 above the rail plane. In the region of the rail network 16, buffer stores are designed in addition to the central store 13. Moreover, further intermediate stores may be assigned to the transport system 15 or, respectively, the rail network 16 in addition to the central store 13. These decentralised stores 20, comprising at least one storage shelf, also belong to the storage system 14. In addition to the transfer units 17, the buffer stores and/or the intermediate stores may also request full and/or empty transport units 12 from the material flow control 18. By means of the transport vehicles 30, deliveries are also made to the buffer stores and/or the intermediate stores. Finally, previously defined portions of the rail network 16 may also serve as intermediate stores or buffer stores and correspondingly initiate transport tasks.

The central store 13 and/or each distributed, i.e. decentralised, store 20 are arranged in the vicinity of the production stations 11 in an optimised manner in terms of distance. This means that as far as possible said stores have the same section lengths from the most remote destinations. Thus short conveying sections or, respectively, conveying times may be achieved. This may also be achieved by short-cuts of the conveying section, so-called short cuts, being provided in the rail network 16. These measures also lead to the conveying sections being uniformly utilised and blockages being avoided.

The transport tasks may be given their priorities in sequence. The priority may be determined in different ways by the material flow control 18, for example from the urgency and/or the priority of a material and/or the priority of a transfer unit 17 or, respectively, production station 11 and/or the priority of a buffer store or an intermediate store and/or the priority of production tasks. For example, the remaining running time of the production station 11 communicated by the transfer unit 17 when requested in step a) is used as a basis for determining the urgency. The remaining running time is calculated, for example, from the production speed of the production station 11.

The transport tasks may be assigned by the material flow control 18 to those transport vehicles 30 which require the shortest overall time for carrying out the transport task, considering the start-up time and the conveying time. To this end, the selected or, respectively, tasked transport vehicles 30 may optionally start from the central store 13, the decentralised store 20, the buffer store or any other position of the rail network 16. The start-up time is calculated as the time which an empty transport vehicle 30, i.e. a transport vehicle 30 without a transport unit 12, requires in order to retrieve or, respectively, load up a transport unit 12. As soon as the transport vehicle 30 is loaded with the requested transport unit 12, the conveying time starts and the conveying time ends when the transfer unit 17 initiating the transport task is reached. As a result, the overall time for carrying out the transport task is optimised. A reduced conveying time may also be achieved by controlling the speed of the transport vehicles 30, by said vehicles only moving temporarily at reduced speed over critical sections, for example corners, if required. If different routes to the destination exist in the rail network 16, the most rapid route may be calculated, when determining the most rapid route in addition to the length of the conveying section, the arrival of traffic on the rail network 16 also being taken into consideration.

In order to minimise as far as possible empty journeys of transport vehicles 30 and to reduce the traffic on the rail network 16, two sub-tasks may be carried out in a single transport task by a full transport unit 12 being transferred from the transport vehicle 30 to the transfer unit 17 and subsequently an empty transport unit 12 being transferred by the transfer unit 17 to the same transport vehicle 30 or vice versa. It may even be expedient to permit the transport vehicles 30 to wait at the transfer unit 17 in order to receive again a transport unit 12 correspondingly altered in the filling level, after the transfer of a requested transport unit 12. A further option to minimise the journeys without material, is to start the transport tasks in a store (for example central store 13, decentralised store 20) and to permit the tasks to be terminated there also.

A transport unit 12 may consist of a loaded goods carrier 21. Preferably, however, the transport unit 12 in each case comprises a load carrier 22 and the loaded goods carrier 21. For example simple packaging trays, material receivers or boxes are suitable as load carriers 22. For example, trays (for example for receiving rod-shaped articles), boxes (for example for consumable materials or production aids), mounting plates with or without support shafts (for example bobbins), etc. are cited as loaded goods carriers 21. The loaded goods carriers 21 are preferably adapted to the articles/materials respectively to be transported, so that said articles/materials are preferably located positively and/or non-positively in or on the loaded goods carrier 21. The load carriers 22 are adapted to the loaded goods carriers 21, so that said loaded goods carriers may be transported securely on the load carrier 22 and a simple transfer from the transport vehicle 30 or to the transport vehicle 30 is ensured.

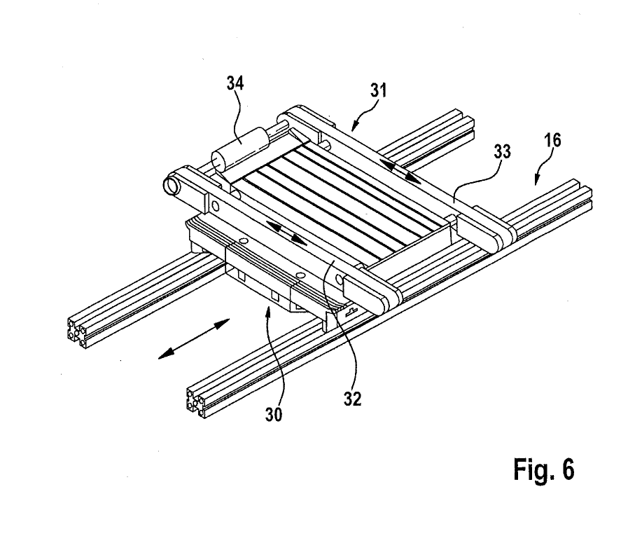

In FIG. 6, an exemplary embodiment of a transport vehicle 30 is shown. The transport vehicles 30 are configured as load carriers and on the upper face remote from the rail network 16 have a transverse conveyor 31 for receiving and dispensing load carriers 22 and/or loaded goods carriers 21 transversely to the direction of travel of the transport vehicle 30. The transverse conveyor 31 may, for example, be a rotating conveyor belt. The transverse conveyor 31 may, for example, also have two conveyor belts 32, 33 arranged spaced apart from one another, which are able to be driven synchronously via a common drive 34. Other embodiments, however, for example with four belts for simultaneous transverse conveyance in the opposing direction are also possible.

After transferring the transport unit 12 from the transport vehicle 30 to the transfer unit 17, the transport unit 12 with the lift arrangement which is optionally assigned to the storage and transport system 14, 15 or preferably the transfer unit 17, is transported vertically downwards into a first transfer plane. In the lower transfer plane, the full or empty loaded goods carrier 21 is removed from the load carrier 22, transported to a station for altering the filling level of the loaded goods carrier 21 and transferred thereto. Alternatively, the transport unit 12 may also initially be lowered together with the transport vehicle 30 in order to transfer the transport unit 12 to the transfer unit 17. As soon as the transfer unit 17 has taken on the transport unit 12 and the transport unit 12 is located in the transfer plane located below the transport plane, the transport unit is supplied, for example by means of a belt conveyor, to the station to alter the filling level.

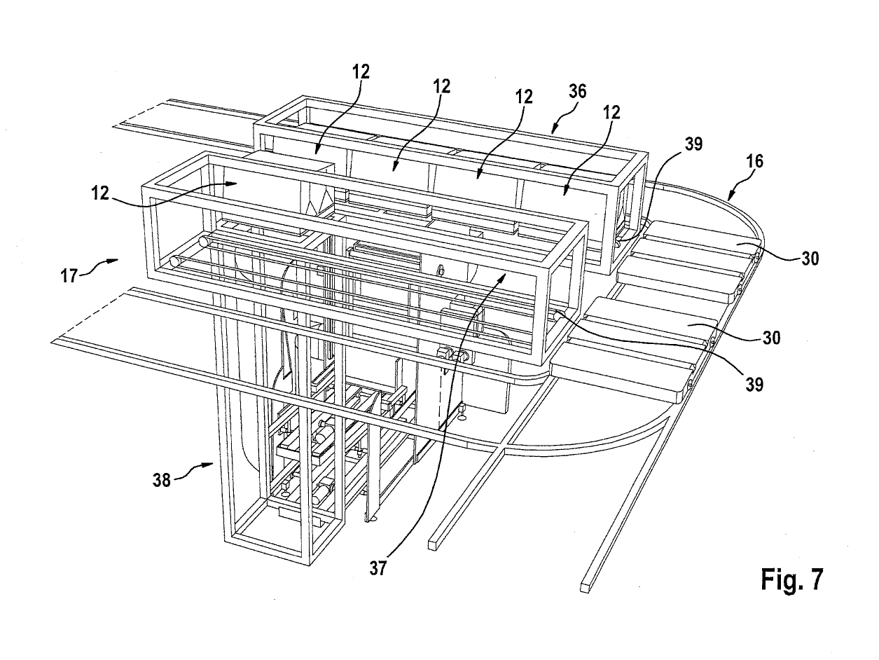

In FIG. 7, by way of example, the functionality of the lift arrangement in the region of a transfer unit 17 is shown. The transfer unit 17 connects the rail network 16 to a production station 11 which is assigned a device 35 for altering the filling level of the trays. The transfer unit 17 has in the example shown a storage region 36 and a transfer region 37. The storage region 36 and transfer region 37 are arranged spaced apart from one another. The transfer region 37 may also be the storage region and the storage region 36 may also be the transfer region. Optionally both regions may also be the storage region, for example for full trays or, respectively, empty trays. In the intermediate space provided by the spacing, a lift 38 which is accessible on both sides is arranged, by means of which trays are able to be transported from top to bottom and vice versa. Both the storage region 36 and the transfer region 37 have conveyor means, for example conveyor belts 39 which are designed and set up for the conveyance of the load carriers 22 and/or the loaded goods carriers 21 from the rail network 16 or, respectively, the transport vehicle 30 moving thereon into the storage region 36 and out of the transfer region 37, on the rail network 16 or, respectively, the transport vehicle 30 moving thereon. Moreover, means are provided by which the load carriers 22 and/or loaded goods carriers 21 (in the conveying plane) may be transported from the storage region 36 into the lift 38 and out of the lift 38 into the transfer region 37. Accordingly, means may be provided by which the load carriers 22 and/or loaded goods carriers 21 (in the lower transfer plane) may be transported from the lift 38 to the device 35, or back again.

After removing the loaded goods carrier 21 from the load carrier 22, the load carrier 22 is either transported with the lift 38 vertically upwards again into the transport plane, in order to dispense it via the transfer region 37 to an available transport vehicle 30, or vertically upwards or downwards into a second transfer plane also located below the transport plane, in order to take on a transport unit 12 with an altered filling level from the same transfer unit 17. The complete transport unit 12 refitted thereby is then transported vertically upwards into the transport plane, in which the transport unit 12 is transferred to an available transport vehicle 30 previously requested and provided by the material flow control.

The central store 13 and/or each distributed or decentralised store 20 and/or each buffer store are controlled or, respectively, managed by a storage management system 23. The program which is preferably assigned to the material flow control 18, controls amongst other things the storage space allocation for the transport units 12, the loading and unloading processes and the stock control. Thus, for example, an inventory is able to be carried out in a simple manner. Individual storage areas, for example for filter rods or cigarettes or bobbins or other production aids, may be managed independently of one another. Further advantages of the storage management system 23 are to carry out the monitoring of the storage duration, for example of filter rods or cigarettes, the blocking of overaged stock, ensuring the FIFO principle as well as recording the movements in the storage and transport system 14, 15. The storage management system 23 also provides an interface for a production planning system (PPS) 24 for preferably stock-based production planning.

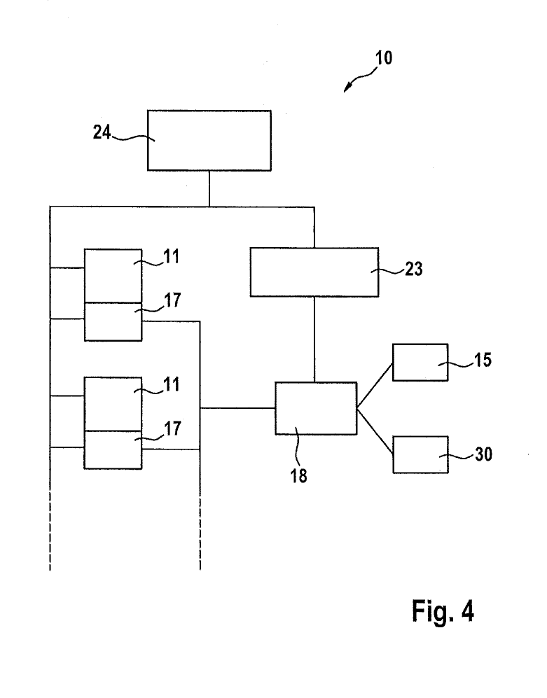

For achieving a demand-based supply of material to the production stations 11 via the system 10, all transfer units 17 are networked to the material flow control 18. Optionally, a further network is provided by which the control of the production stations 11 and the stored stock in the storage system 14 is permitted. Said PPS 24 is networked with all production stations 11 and the storage management system 23. The storage management system 23 in turn is connected by a network to the material flow control 18. The material flow control 18 in turn controls the transport system 15 and the transport vehicles 30 able to move thereon. By the PPS 24, based on individual planning data, individual production tasks are planned for the production stations 11 and distributed to the production stations 11 and the transfer units 17. A production task describes the type and quantity of the articles/products to be produced at a production station 11. Thus all data of the articles/products and materials, which have to be supplied and removed by the intralogistics system 10, are known. Via the network or, respectively, the data connections thereof, the data sets are electronically transmitted to the storage and transport system 14, 15 as well as to the transfer units 17. The transfer units 17 produce therefrom material requests to the transport system 15 for the appropriate transport units 12 which by the material flow control 18 are converted into actual transport tasks. The system 10 illustrated schematically in FIG. 4 is able to be extended by further production stations 11 with an associated transfer unit 17. The intralogistics system 10, as a result, is adaptable or, respectively, extendable individually to different production capacities.

Free transport vehicles 30 and conveying vehicles 30 loaded with full or empty transport units 12 move within the storage and transport system 14, 15 in order, on the one hand, to deliver full or empty transport units 12 to a transfer unit 17 and, on the other hand, to retrieve transport units 12 altered in the filling level from a transfer unit 17. To this end, the transport vehicles 30 do not leave the rail network 16. However, there is also the possibility that the transport vehicles 30 are transferred alone or together with a transport unit 12 from the rail network 16 to the transfer unit 17 and back again when, for example, an ejection of a transport unit 12 from a first intralogistics system 10 of the cigarette and/or filter rod production and an introduction into a second intralogistics system 10 of the cigarette and/or filter rod production is to be achieved.

The method principle initially described above in general terms is described hereinafter by way of example for an actual production or, respectively, transport task and with reference to transfer units 17 with actual transport units 12.

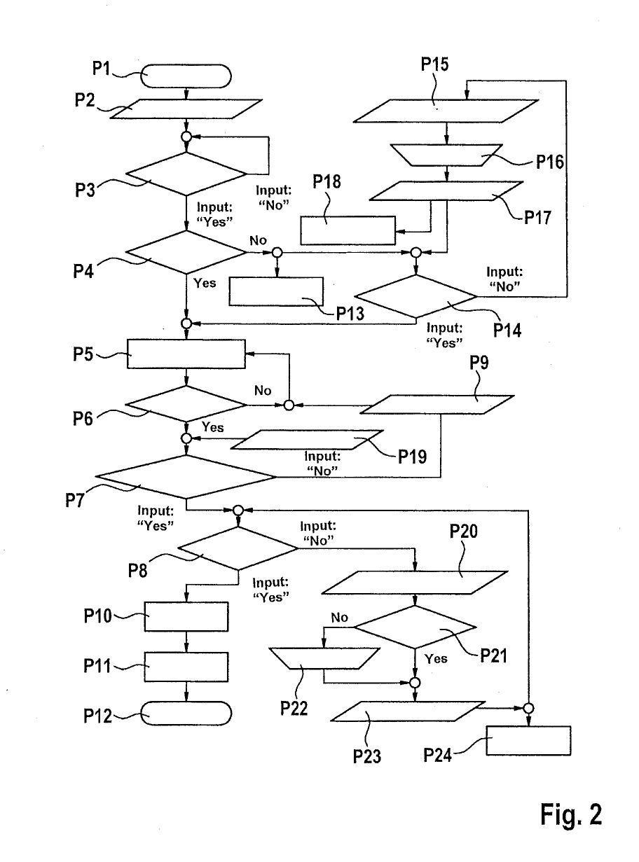

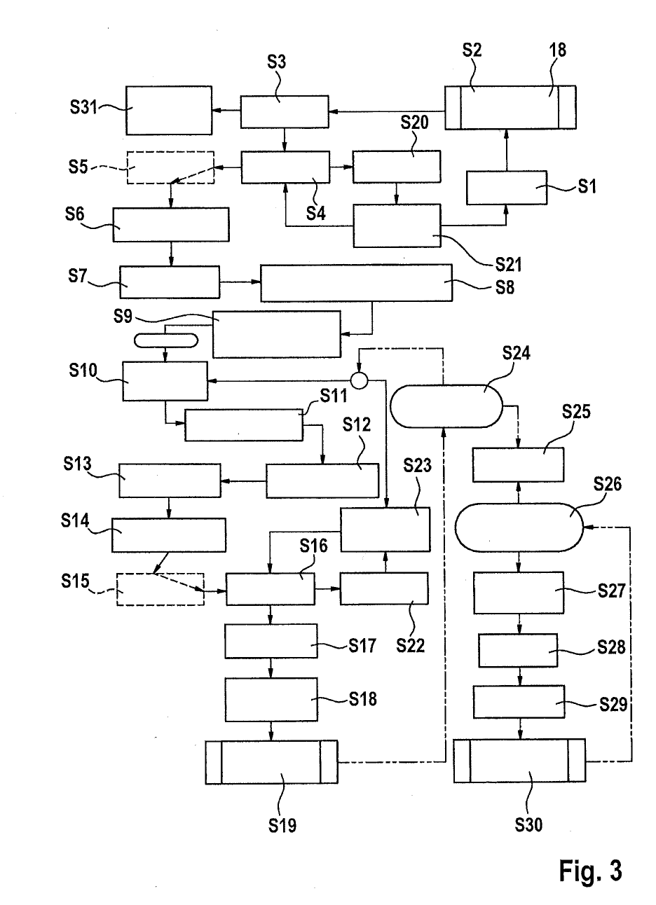

For example, when manufacturing filter rods and cigarettes for customers, so-called production tasks are controlled. A production task describes the type and quantity of articles to be manufactured by the production stations 11. Such production tasks are carried out with a plurality of transport tasks. In the example of a transfer unit 17 for a tray filler, in the initial situation the previous production task is terminated, the full tray station is empty, empty trays on empty tray station are possible, no transport units 12 with full trays are present in the reservoir of the transfer unit 17 and transport units 12 with empty trays are possible in the reservoir of the transfer unit 17, for example the following sequence according to FIG. 2: after, for example, manual input of a production task (see step P1) a production task is set up (see step P2). After a query as to whether it is actually intended to be started (see step P3), a production task is started. Then initially the type of empty trays is checked (see step P4). When altering the type of empty trays, the empty tray station and the reservoir of the transfer unit 17 are run empty and the appropriate empty trays are requested. If the appropriate empty trays are available, the production task is carried out, namely empty trays are delivered and full trays retrieved (see step P5). Detailed implementation of a transport task on a transfer unit 17 assigned to a tray filler, is described in more detail below with reference to FIG. 3.

If the production quantity is reached (query see step P6) or the production task is to be interrupted, it is queried whether the production task is actually intended to be terminated (see step P7). If this is the case, it is also queried whether the full tray station is empty (see step P8). If required or desired, i.e. when the production task is to be continued, the required remaining quantity may be input and the production task started again (see step P9). After terminating the production task, i.e. when the production quantity is reached, the full trays are retrieved from the reservoir of the transfer unit 17 and transferred to transport vehicles 30 which transport the full trays away (see step P10), for example into the central store 13. After identifying the end of the production task (see step P11), the production task is terminated (step P12).

In FIG. 2, further method steps are illustrated which may be optionally implemented. Proceeding from step P4, in the event that a production task is not yet intended to be carried out, step P13 may also follow, by which an exchange of trays may be initiated, empty trays of the first type being retrieved and transported to the store when the type of tray is changed. If in the query “is the empty tray station empty?” (step P14) it is established that said tray station is empty, the process may be continued with step P5. In the event that the empty tray station is not empty, with a corresponding input it is skipped to step P15, with the message “prepare empty tray block for retrieval at full tray station”. Such an empty tray block, for example a block of four, is then prepared (step P16). The preparation is acknowledged (step P17). The empty tray block may then be retrieved and transported to the store (step P18) or via step P14 lead to the production task (step P5).

If a production task is to be interrupted, said step P19 has to be input or, respectively, implemented before terminating the production task (step P7). If the answer to the query is negative relative to the full tray station (step P8), i.e. when the full tray station is not yet empty, the message is emitted “prepare block for retrieval at full tray station” in step P20. If the answer to the query “blocks on full tray station?” (step P21) is “yes”, the preparation is acknowledged (step P23). If the answer to the query is “no” the full tray station is filled with empty trays (step P22) and then acknowledged (step P23). Subsequently, the full trays are retrieved and stored (step P24).

Hereinafter, the handling in step P5 of trays, i.e. transport containers for rod-shaped articles, such as for example filter rods or cigarettes, within the intralogistics system 10 or, respectively, on the transfer unit 17, is described in particular with reference to FIG. 3. At least one transfer unit 17 which is assigned to a tray filler as an apparatus for altering the filling level, which in turn is assigned to a maker, namely a filter manufacturing machine or a cigarette manufacturing machine, requests empty trays as loaded goods carriers 21 for receiving rod-shaped articles (see step S1). Said empty trays are either already available on a transport vehicle 30 or a transport vehicle 30 retrieves and takes the requested empty trays from the storage system 14. The empty trays may be handled individually or as a block of several combined empty trays. The transport vehicle 30 transports the empty tray(s) to the transfer unit 17 (see step S2) and transfers the load carrier 22 with the empty tray or the empty trays to the transfer unit 17 (see step S3). Subsequently, the transport units 12 are transported to the lift arrangement (see step S4). The trays, i.e. also the empty trays, may be provided with a guard hood 26 or the like for protection of the articles to be conveyed therein. The encapsulation achieved thereby of the empty trays serves (after filling) as aroma protection and as protection against the drying-out of articles.

In the event that the empty trays are covered by such a guard hood 26, the guard hood 26 is separated from the transport unit 12 (see step S5). Subsequently, the empty trays together with the load carrier 22 are transported by the lift arrangement into the lower transfer plane (see step S6). In the case where no guard hood 26 is provided, the empty trays are transported directly after receipt into the lower transfer plane, removed there from the load carrier 22 (see step S7) and transported to the tray filler (see step S8) and transferred thereto or, respectively, to the belt station supplying the tray filler (see step S9).

Preferably, trays filled from the tray filler are than transferred as full trays from the belt station discharging from the tray filler to the transfer unit 17 and transferred therefrom to a requested load carrier 22. To this end, the load carriers 22 are moved vertically upwards or downwards, for example by means of the lift arrangement, to the discharging belt station (see step S10). Said load carrier 22 may already be available on the transfer unit 17 or be delivered by a transport vehicle 30. If a full tray or a plurality of full trays combined to form a block are taken by the tray filler (see step S11), transported to the load carrier 22 (see step S12) and deposited on the load carrier 22 (see step S13) the inclination of the full trays may be optionally altered in order to prevent the articles from falling out. The full transport units 12 formed by the load carrier 22 and the full trays are transported by the lift arrangement vertically upwards into the transport plane (see step S14) and transferred there to the requested transport vehicle 30. Optionally, before the transfer to the transport vehicle 30 a guard hood 26 may be supplied again (see step S15) in order to protect the articles located in the (full) trays. After upward conveyance by the lift arrangement, the transport units 12 are transported into the transfer position (see step S16) and prepared there for transfer to a previously requested transport vehicle 30 (see step S17). Both the empty trays when supplied to the transfer unit 17 and the full trays when discharged from the transfer unit 17 may either be directly used or, respectively, forwarded on. Optionally, the empty trays and/or full trays may also be temporarily stored on the transfer unit 17.

Accordingly, the method is also implemented when at least one transfer unit 17 which is assigned to a tray discharger as an apparatus for altering the filling level, which in turn is assigned to a maker, namely a filter assembly machine or a packaging machine or a multi-segment filter manufacturing machine, requests full trays as loaded goods carriers 21 (see step S1). Said full trays are either already available on a transport vehicle 30 or a transport vehicle 30 retrieves and takes the requested full trays from the storage system 14. The full trays may be handled individually or as a block of several full trays combined together. The transport vehicle 30 transports the full tray(s) to the transfer unit 17 (see step S2) and transfers the load carrier 22 with the full tray or the full trays to the transfer unit 17 (see step S3). Subsequently, the transport units 12 are transported to the lift arrangement (see step S4). The trays, i.e. in particular also the full trays, may be provided with a guard hood 26 or the like for protecting the articles to be transported therein. The encapsulation thereby achieved of the full trays serves (after filling), for example, as aroma protection or as protection against the drying-out of articles.

In the event that the full trays are covered by such a guard hood 26, the guard hood 26 is separated from the transport unit 12 (see step S5). Subsequently, the full trays together with the load carrier 22 are transported by the lift arrangement into the lower transfer plane (see step S6). In the event that no guard hood 26 is provided, the full trays, directly after being taken, are transported into the lower transfer plane, removed there from the load carrier 22 (see step S7) and transported to the tray discharger (see step S8) and transferred thereto or, respectively, to the belt station supplying the tray discharger (see step S9).

Preferably, trays emptied by the tray discharger are then transferred to the transfer unit 17 as empty trays from the belt station discharging from the tray discharger and transferred therefrom to a requested load carrier 22. To this end, the load carriers 22 are moved vertically upwards or downwards, for example by means of the lift arrangement to the discharging belt station (see step S10). Said load carrier 22 may already be available on the transfer unit 17 or be delivered by a transport vehicle 30. An empty tray or several empty trays combined to form a block are taken by the tray discharger (see step S11), transported to the load carrier 22 (see step S12) and deposited on the load carrier 22 (see step S13). The empty transport units 12 formed from the load carrier 22 and the empty trays are conveyed by the lift arrangement vertically upwards into the transport plane (see step S14) and transferred there to the requested transport vehicle 30. Optionally, before the transfer to the transport vehicle 30, again a guard hood 26 may be supplied (see step S15) in order to prepare the empty trays for the next transport task. After the upward conveyance by the lift arrangement, the transport units 12 are transported into the transfer position (see step S16) and prepared there for transfer to a previously requested transport vehicle 30 (see step S17). Both the full trays when supplied to the transfer unit 17 and the empty trays when removed from the transfer unit 17 may either be directly used or, respectively, forwarded on. Optionally, the full trays and/or empty trays may also be temporarily stored on the transfer unit 17.

Further possible method steps are described in the example of FIG. 3. The transport units 12 with full trays or empty trays may be stored (step S20) after being taken on by the transfer unit 17 (step S3/S4) or again removed from the reservoir (step S21). After the transport units 12 have been prepared in step S17, a retrieval may be requested (step S18). By the retrieval (step S19) of the transport units 12, the exemplary handling of full trays or empty trays is terminated. At the end of a so-called production task, the system may be run empty (step S24). To this end, empty or, respectively, free transport vehicles 30 may be requested (step S25).

At the start of a production task, empty trays or full trays may be retrieved (step S26). To this end, transport units 12 with full trays or empty trays are removed from the reservoir (step S27), transported (step S28), prepared (step S29) and then retrieved (step S30). After taking the transport unit 12 from the transfer unit 17 (step S3) the delivery of full trays or empty trays may still be confirmed (step S31).

In addition to the trays, bobbins may also be automatically handled within the intralogistics system 10. To this end, at least one transfer unit 17 is assigned to a bobbin loader which in turn is assigned to a maker, namely a filter manufacturing machine or a cigarette manufacturing machine or a packaging machine. This transfer unit 17 requests a load carrier 22 with a loaded goods carrier 21 carrying at least one bobbin. Alternatively, the bobbin or each bobbin may also be located directly on the load carrier 22. After the transfer unit 17 has taken on the transport unit 12 including the bobbins or the bobbin stack, the transport unit 12 is conveyed into the lower transfer plane, removed there from the load carrier 22 and transported to the maker and transferred thereto. The load carrier 22 without the loaded goods carrier is subsequently transported from the transfer plane upwards into the transport plane and transferred there to the requested transport vehicle 30 so that the empty load carrier 22 is incorporated in the storage and transport system 14, 15 for further use.

Alternatively, the load carrier 22 may be removed with the bobbin or stack of bobbins from the transport vehicle 30 and transferred to the transfer unit 17. The bobbin or each bobbin is then able to be gripped and lifted from the load carrier 22, so that the load carrier which is now free is then transferred back to the transport vehicle 30. The bobbin or each bobbin is then transported without the load carrier 22 vertically downwards out of the transport plane into the transfer plane, for example directly into the storage region of the bobbin loader. A reverse sequence is possible, for example, when unused bobbins, for example when changing brands, are introduced back into the storage and transport system 14, 15. To this end, a free load carrier 22 is requested by the transfer unit 17.

Moreover, spare parts and/or wearing parts may also be automatically handled within the intralogistics system 10 as production aids including, in particular, so-called “non-tobacco materials” (in short NTM) such as for example glue, suction belts or blades as wearing parts or spare parts of the production stations and further packaging materials not wound onto bobbins, such as blanks. To this end, at least one transfer unit 17 requests a load carrier 22 with a loaded goods carrier 21 receiving production aids, for example a box, the loaded goods carrier 21 carrying the production aids together with the load carrier 22—alternatively also without said load carrier—after transfer to the transfer unit 17 being transported into the lower transfer plane and removed there from the load carrier 22. The load carrier 22 with empty loaded goods carrier or without the loaded goods carrier 21 is subsequently transported from the transfer plane vertically upwards into the transport plane and transferred there to the requested transport vehicle 30, so that the free load carrier 22 or, respectively, the empty loaded goods carrier 21 is introduced for further use into the storage and transport system 14, 15′. The spare parts and/or wearing parts and all other production aids may be retrieved from a separate reservoir which is associated with the storage system 14 or retrieved from the central store 13 or, respectively, decentralised store 20. Residual stock and replacement parts may also be transported in the reverse direction. To this end, a free load carrier 22 is requested by the transfer unit 17. The supply or, respectively, request of spare parts and/or wearing parts may be initiated by an operator at the production stations 11 or by working plans or maintenance plans stored in the material flow control 18. In this case, for example predetermined replacement cycles may be stored. Optionally, the need for spare parts and/or wearing parts and production aids may also be determined or, respectively, detected on-line and accordingly communicated.

To the rear of the transfer units 17, instead of the makers and packers manual working spaces may also be provided, wherein the transfer units 17 then transport the transport units 12 to a transfer space for manual handling. Accordingly, transport units 12 at the transfer space may also be manually introduced into the transfer unit 17. Moreover, there is the possibility of supplying the transport units 12 by means of the transfer unit 17 to a tray carriage or other mobile units for receiving and for the conveyance or, respectively, distribution of transport units 12.

The intralogistics system 10 optionally also contains a product tracking system. The transport vehicles 30 and/or the load carriers 22 and/or the loaded goods carriers 21 and/or the material to be transported are localised and/or tracked by machine-readable and/or electronic identification carriers. The transport vehicles 30 may also be navigated by a satellite navigation system, for example the Global Positioning System (GPS) within the transport system 15, in this case a system of at least one, preferably however a plurality of, indoor transmitters being used.

The product tracking system extends not only to the storage and transport system 14, 15 but also to the transfer units 17 as well as the components and regions associated therewith. For example, the loaded goods carriers 21 (for example the trays) or the load carriers 22 as well as materials (for example bobbins) may be provided with so-called RFID tags, barcodes or other electronically readable labels. With corresponding identification or, respectively, reading devices, which are positioned at selected positions, the trackability of all movements in the intralogistics system 10 may be ensured. The product tracking system also permits the assignment of initial materials to end products in batches as well as the packaged end products to the individual production stations 11 which also simplifies the introduction of quality securing measures. Moreover, by means of the product tracking system mis-deliveries may also be eliminated or, respectively, identified and materials not suitable for further processing may be ejected.

The product tracking system is achieved, for example, by recording all material movements in the storage and transport system 14, 15 as well as the components and regions associated therewith. The transport units 12 may be monitored with each loading and unloading of a transport vehicle 30. If an error is established, the material flow may be controlled according to individual criteria. For example, the empty trays on the tray filler are initially checked and the full trays after filling identified by production data on machine-readable identification carriers. On the tray discharger, the empty trays are identified and the full trays or, respectively, the product data thereof monitored. In a further example, which may be implemented per se or in combination with the above-mentioned examples, bobbins are monitored when supplied into the transport system 15 and/or when removed, for example, from the transfer unit 17 to the bobbin loader using machine-readable identification carriers.

Empty trays may be completely emptied and/or cleaned in the vicinity of the tray discharger and/or directly before supply to the tray filler. This method is denoted as providing the conformity of empty trays. By the emptying and/or cleaning it is ensured that the empty trays are actually empty before they are filled. The cleaning may, for example, take place by using brushes. Other cleaning methods, for example blowing-out, etc. however, may also be used. The contaminants arising during cleaning/cleansing may be collected and disposed of.

Ensuring the conformity of the full trays takes place by each full tray after filling being checked for conformity manually or by automatic means. For example, the filling level is measured or the filling image monitored. If the result of the checking is that the monitored full tray does not fulfil the predetermined criteria, a message is emitted to the material flow control 18 and the supply of the full tray to the storage and transport system 14, 15 is prevented.

The same may be carried out for the bobbins. The bobbins are also manually or automatically checked for their conformity, when transferred by means of a transfer unit 17 from the storage system 14 to the transport system 15. Such bobbins which are identified as not having conformity are prevented from being introduced into the transport system 15. If, for example, a device for automatic monitoring of the bobbins establishes that said bobbin does not have conformity, i.e. for example has been telescoped, the device provides a message to the material flow control 18.

A further option for the method according to the invention is that transport units 12 and, in particular, loaded goods carriers 21, namely full trays filled with rod-shaped articles, are weighed before storage in the storage system and after removal from the storage system. The weighing may also take place directly after filling the full trays and directly before emptying. A weight difference is determined and recorded from the weight measurements for one and the same full tray. If an upper limit value is exceeded or a lower limit value not reached, the ejection of the loaded goods carrier 21 from the storage and transport system 14, 15 is initiated via a transfer unit 17. For example, a full tray filled with cigarettes is weighed when stored in the storage system 14. After a storage time of several hours, in which the cigarettes dry out and as a result lose weight, this full tray is weighed again when removed from storage. If a large weight difference, i.e. a high level of drying-out, is determined, this full tray is blocked from further processing and optionally ejected. The measuring means, i.e. scales, may be arranged at different positions of the intralogistics system 10.

Moreover, full loaded goods carriers 21, i.e. provided with material, may be transferred directly from the storage and transport system 14, 15 into a quality control securing station 25. The ejection for checking purposes takes place according to predetermined criteria and/or randomly. The transport units 12 or, respectively, the loaded goods carriers 21 may be transferred directly to a central transfer point from the transport system 15 to the quality securing station 25 or by means of a transfer unit 17 to said quality securing station. Preferably, the quality control relates to the monitoring of filters and cigarettes. However, optionally all materials relevant for processing and production, i.e. in particular bobbins and the production aids mentioned above, may be monitored in the quality securing station 25.

1. A method for a demand-controlled supply to and disposal away from at least two production stations associated with an overhead storage and transport system including: a rail network having a rail; self-propelled transport vehicles and transport units being moved on the rail by the self-propelled transport vehicles; a storage system including a central store comprising at least one storage shelf; and a material flow control, the method comprising:
a) requesting a full or empty transport unit which is available within the storage and transport system, by a transfer unit of an associated production station initiating a transport task, said transfer unit forming a linking member between the storage and transport system and the associated production station, with a material flow control;
b) assigning the transport task by the material flow control to the transport vehicle having the requested full or empty transport unit;
c) moving the transport vehicle with the full or empty transport unit in a transport plane on the rail network from a start position of the transport vehicle as far as the transfer unit of the production station initiating the transport task, said production station being located in a production plane below the transport plane;
d) transferring the full or empty transport unit from the transport vehicle to the transfer unit in a transfer position; and
e) lowering the full or empty transport unit via a lift arrangement from the transport plane into a transfer plane located below the transport plane,
wherein steps d) and e) are selectively carried out in reverse sequence and the transport vehicle is released for a next transport task after the transfer of the full or empty transport unit to the transfer unit.

2. The method according to claim 1, wherein the storage system comprises a decentralized store including at least one of buffer stores configured in a region of the rail network and intermediate stores assigned to the transport system having at least one storage shelf, wherein the requesting step further includes requesting, by at least one of the buffer stores and the intermediate stores, full or empty transport units with the material flow control, and delivering transport vehicles thereto.

3. The method according to claim 2, further comprising assigning priorities by the material flow control to transport tasks in sequence, wherein the priorities are selectively determined from at least one of an urgency or a precedence of a material, a precedence of a transfer unit or, respectively, a production station, a precedence of a buffer store or an intermediate store and a precedence of production tasks by the material flow control.

4. The method according to claim 1, wherein the assigning includes assigning transport tasks by the material flow control to transport vehicles which require a shortest overall time for carrying out the transport task, considering the start-up time and the transport time.

5. The method according to claim 1, including handling two sub-tasks by a single transport task by transferring a full transport unit from the transport vehicle to the transfer unit and subsequently transferring an empty transport unit from the transfer unit to a same transport vehicle, or vice versa.

6. The method according to claim 1, further including transporting by the lift arrangement, the full or empty transport units, which in each case is formed from a load carrier and a loaded goods carrier, vertically downwards into a first transfer plane after transfer from the transport vehicle to the transfer unit; removing the full or empty loaded goods carrier from the load carrier in the lower transfer plane; and transporting and transferring the full or empty loaded goods carrier to a station for altering a filling level of the loaded goods carrier.

7. The method according to claim 6, further including: after removing the loaded goods carrier, transporting the load carrier vertically downwards or upwards into a second transfer plane located below the transport plane, in order to receive a loaded goods carrier with an altered filling level; and transferring the loaded goods carrier with the altered filling level to the load carrier; then transporting the transport unit reset thereby vertically upwards into the transport plane; and transferring the transport unit to a transport vehicle previously requested and provided by the material flow control.

8. The method according to claim 2, further including controlling or respectively managing at least one of the central store and the decentralised store, by a storage management system.

9. The method according to claim 1, further including moving free transport vehicles and conveying vehicles provided with full or empty transport units within the storage and transport system in order to deliver, on the one hand, full or empty transport units to a transfer unit and, on the other hand, to retrieve transport units altered in a filling level from a transfer unit.

10. The method according to claim 6, wherein the production machines are of the tobacco processing industry, the method further including: requesting, by at least one transfer unit which is assigned to a tray filler, which in turn is assigned to a filter manufacturing machine or a cigarette manufacturing machine, empty trays as loaded goods carriers to receive rod-shaped articles; transporting the empty trays together with the load carrier into the lower transfer plane; removing the empty trays from the load carrier; and transporting and transferring the empty trays to a tray filler.

11. The method according to claim 10, further including transferring the trays filled by the tray filler back to the transfer unit and transferring said trays from said transfer unit to a requested load carrier which is optionally already available at the transfer unit or delivered by a transport vehicle; transporting the full transport units formed from the load carrier and trays from the transfer plane upwards into the transport plane and transferring said full transport units and trays at the transport plane to a requested transport vehicle for introducing the full transport unit into the storage and transport system for further use.

12. The method according to claim 6, wherein the production machines are of the tobacco processing industry, the method further including: requesting, by at least one transfer unit which is assigned to a tray discharger which in turn is assigned to a filter assembly machine or a packaging machine or a multi-segment filter manufacturing machine, full trays as loaded goods carriers with rod-shaped articles; transporting the full trays together with the load carrier into the lower transfer plane; removing the full trays from the load carrier; and transporting and transferring the full trays to a tray discharger.

13. The method according to claim 12, further including transferring trays emptied by the tray discharger back to the transfer unit; transferring the emptied trays from said transfer unit to a requested load carrier which optionally is already available at the transfer unit or delivered by a transport vehicle; transporting empty transport units formed from the load carriers and trays from the transfer plane upwards into the transport plane; and transferring said empty transport units and trays to a requested transport vehicle for introducing the empty transport unit into the storage and transport system for further use.

14. The method according to claim 10, further including removing a guard hood assigned to a load carrier from the load carrier before being transported into the transfer plane and placing the guard hood onto the load carrier after being transported back into the transport plane.

15. The method according to claim 6, wherein the production machines are of the tobacco processing industry, the method further including: requesting, by at least one transfer unit which is assigned to a bobbin loader which in turn is assigned to a maker, including a filter manufacturing machine or a cigarette manufacturing machine or a packaging machine or a film wrapper, a load carrier with a loaded goods carrier carrying at least one bobbin; transporting the at least one loaded goods carrier carrying the at least one bobbin together with the load carrier into the lower transfer plane; removing the loaded goods carrier from the load carrier; transporting and transferring the loaded goods carrier to the maker; subsequently transporting the load carrier which is without a loaded goods carrier from the transfer plane upwardly into the transport plane and transferring said load carrier at the transport plane to a requested transport vehicle for introducing the empty load carrier into the storage and transport system for further use.

16. The method according to claim 6, the method further including: requesting, by at least one transfer unit, a load carrier with a loaded goods carrier receiving at least one of spare parts and wearing parts; transporting the loaded goods carrier carrying the at least one of spare parts and wearing parts, together with the load carrier into the lower transfer plane; removing the loaded goods carrier from the load carrier; subsequently transporting the load carrier, with an empty loaded goods carrier or without a loaded goods carrier, from the transfer plane upwards into the transport plane; and transferring said load carrier at the transport plane to a requested transport vehicle for introducing a free load carrier or, respectively, an empty loaded goods carrier for further use into the storage and transport system.

17. The method according to claim 16, further including initiating the request by the transfer unit with the spare parts and/or wearing parts by one of an operator, or a maintenance plan or a requirement plan stored in the material flow control.

18. The method according to claim 15, wherein the requesting includes requesting a free load carrier by a transfer unit in order to retrieve a loaded goods carrier provided with a tail strip.

19. The method according to claim 6, further including storing a full or, respectively, loaded and empty loaded goods carriers stored in one of the central store, decentralised store, or buffer store, on the rail network, or directly in the transfer unit with or without the load carrier and with or without the transport vehicle.

20. The method according to claim 6, further including at least one of localizing and tracking at least one of the transport vehicles, the load carriers, the loaded goods carriers, and the material to be transported by at least one of machine-readable and electronic identification carriers.

21. The method according to claim 20, wherein the at least one of localizing and tracking takes place via a satellite navigation system and at least one indoor transmitter.

22. The method according to claim 12, further comprising at least one of fully emptying and cleaning empty trays in a vicinity of the tray discharger or immediately before being supplied to a tray filler.

23. The method according to claim 10, further comprising checking, in a region between the tray filler and the transfer unit, the full trays after being filled in the tray filler for conformity; and preventing full trays which are identified as not having conformity from being introduced into the storage and transport system.

24. The method according to claim 15, further comprising checking the at least one bobbin when transferred by the transfer unit from the storage system to the transport system, for their conformity; and preventing bobbins identified as not having conformity from being introduced into the transport system.

25. The method according to claim 6, further including weighing the loaded goods carrier before storing in the storage system and after removing from the storage system.

26. The method according to claim 25, further including detecting a weight difference which, when exceeding an upper limit value and when falling below a lower limit value, initiates an ejection of loaded goods carriers from the storage and transport system via a transfer unit.

27. The method according to claim 6, further including transferring fully loaded goods carriers, according to by one of predetermined criteria or randomly, directly from the storage and transport system into a quality securing station.
